(19) United States
(12) Patent Application Publication
(10) Pub. No.: US 2021/0370998 A1
(43) Pub. Date: Dec. 2, 2021

(54) SEAT FOR INFANTS AND TODDLERS EQUIPPED WITH VENTILATION COOLING DEVICE

(71) Applicant: Bo Moon SEO, Daegu (KR)

(72) Inventor: Bo Moon SEO, Daegu (KR)

(21) Appl. No.: 17/286,723

(22) PCT Filed: May 24, 2019
(86) PCT No.: PCT/KR2019/006276

§ 371 Date: Apr. 19, 2021

(30) Foreign Application Priority Data
Jan. 31, 2019 (KR) 20-2019-0000491

(51) Int. Cl. B62B 9/10; A47C 7/74; A47C 31/00; A47C 7/02

(52) U.S. Cl. CPC B62B 9/102; A47C 7/744; B62B 2204/04; A47C 7/021; A47C 31/008

(57) ABSTRACT

The present invention relates to a seat for infants and toddlers equipped with a ventilation cooling device, the seat comprising: an upper plate (10) in which a plurality of air intake ports (101) and air exhaust ports (102) are formed; a lower plate (20) coupled to a lower portion of the upper plate (10), and having an internal space partitioned, by means of a partition wall (201), into an intake space (202) and an exhaust space (203), wherein the two spaces communicate with each other through a vent portion (201a) having a predetermined size formed in the partition wall (201); a blowing fan (30), installed inside the intake space (202), for intaking air that is outside the air intake ports (101) and discharging same through the air exhaust ports (102) that communicate with the exhaust space (203); a power supply unit (40) for supplying power to the blowing fan (30); and an air guide (50), formed at a lower portion of the air exhaust ports (102), for guiding air discharge. According to the present invention, ventilation between a baby's body part in close contact with a seat surface and the seat surface in close contact with the body part, and cooling corresponding to the ventilation are smoothly performed by means of the blowing fan, such that excellent comfort can be provided, and it is possible to carry and store the seat easily.

### FIELD OF INVENTION

The present invention relates to a seat for infants and toddlers equipped with a ventilation cooling device, and more specifically, in which an air blowing fan is provided to enable smooth ventilation and cooling between a body part of the baby and the seat surface in close contact with the body part by the same, thereby providing excellent comfort while having advantages of easy carrying and storage.

### BACKGROUND OF INVENTION

As the economy and technology are being developed, demand for infant and toddler products is gradually diversifying. There among, a seat for infants and toddlers is seated or installed inside a stroller or a chair to provide comfort when a baby is laying or sitting on the stroller or chair. However, the conventional seat for infants and toddlers (“seat”) has a disadvantage in that this is mostly made of a fabric product having a predetermined thickness filled with a cushioning material therein, thus involving no other function except for providing comfort.

Further, some products are made of poor fabric materials, which causes poor ventilation so that, even if a baby lies down or sits for a short time, the skin temperature rises, causing sweating and discomfort. In addition, there is a disadvantage of sweating or various skin ailments due to the lack of rapid drying of the sweat. In order to overcome such drawbacks, there was disclosed a ventilation cushion in which a plurality of ventilation holes having a hexagonal cross-section is continuously formed through upper and lower sides of a joint surface so as to entirely form a honeycomb structure, thereby achieving excellent ventilation.

However, in the conventional ventilation cushion, the ventilation hole is formed vertically and the ventilation part is formed only on the upper and lower surface. Therefore, the ventilation cushion is typically disposed on the seat of a chair and, when the baby sits on the upper surface of the ventilation cushion, the upper and lower ventilation parts of the ventilation hole are blocked, thus inhibiting smooth ventilation.

### SUMMARY OF INVENTION

### Technical Problem to be Solved

The present disclosure has been proposed to overcome the aforementioned problems, and an object of the present invention is to provide a seat for infants or toddlers equipped with a ventilation cooling device, in which a blowing fan is installed inside so that ventilation and cooling are smoothly performed between a body portion of a baby and a seat surface in close contact with the body portion by the blowing fan.

### Technical Solution

In order to accomplish the above object, the present invention provides a seat for infants and toddlers equipped with a ventilation cooling device, which includes: an upper plate 10 in which a plurality of air intake ports 101 and air exhaust ports 102 is formed;

a lower plate 20 coupled to the bottom of the upper plate 10, and having an inner space partitioned into an air intake space 202 and an air exhaust space 203 by a partition wall 201, wherein these two spaces communicate with each other through a vent 201a with a predetermined size formed in the partition wall 201;

a blowing fan 30 installed inside the air intake space 202 in order to intake air outside through the air intake ports 101 and then exhaust the same through the air exhaust ports 102 communicating with the air exhaust space 203; a power supply unit 40 to supply power to the blowing fan 30; and an air guide 50 disposed at a lower portion of the air exhaust ports 102 to guide air discharge. An area ratio between the air intake space 202 and the air exhaust space 203 present in the lower plate 20 may be 4:6. The air guide 50 may include: a first air guide 50a which is formed in plural at a predetermined interval adjacent to the blowing fan 30 while having a lower surface to be spaced apart from the bottom surface of the lower plate 20; and a second air guide 50b which is formed in plural at a predetermined interval to be more spaced apart from the blowing fan 30 than the first air guide 50a, wherein the first air guides 50a and the second air guides 50b are disposed in a zigzag mode on a plane, and each second air guide 50b has a larger size than each first air guide 50a while a lower surface thereof is in close contact with the bottom surface of the lower plate 20.

The air guide 50 may be form in a column shape having a triangular cross-section, wherein a slope inducing surface 501 is formed to be connected to the air exhaust port 102 on one side of the air guide, and the slope inducing surface 501 is formed to be concave inwardly.

The air guide 50 may further include a vortex preventing surface 502 provided symmetrically on the other side thereof, which is convex outwardly.

The upper plate 10 may further include a pressure sensor 601 on one side thereof, which senses pressure applied to the top surface of the upper plate and transmits a signal for controlling power supply to the power supply unit 40.

At one side of the upper plate 10:

a temperature sensor 602 for measuring ambient temperature;

a humidity sensor 603 for measuring ambient humidity; and

a control module 604 that transmits a temperature measured by the temperature sensor 602 and a humidity measured by the humidity sensor 603 to a mobile terminal 70, while receiving a control signal from the mobile terminal 70, so as to control the blowing fan 30.

### Effect of Invention

According to the present invention, ventilation and cooling may be smoothly performed between a body portion of a baby and a seat surface in close contact with the body portion by the blowing fan, so as to inhibit sweating of the baby and impart excellent comfort, simultaneously, thereby attaining effects of preventing occurrence of heat rash or various skin diseases caused by sweat.

Further, air is uniformly discharged through a plurality of air exhaust holes formed on the upper plate to allow air circulation, thereby minimizing a change in wind volume on topical parts of the body and thus preventing ventilation and cooling effects from being biased to any part.

Further, since a portable battery may be used as a power source for the blowing fan, it is easy to carry and store the seat of the present invention.

In addition, the inner space is divided into an air intake space and an air exhaust space and a blowing fan is disposed appropriately in the air intake space so as to smoothly circulate air while improving efficiency of the blowing fan, thereby reducing both power consumption and noise.

### BRIEF DESCRIPTION OF DRAWINGS

FIG. 1 is a perspective view illustrating the seat for infants and toddlers equipped with a ventilation cooling device according to an embodiment of the present invention.

FIG. 2 is an exploded perspective view illustrating the seat for infants and toddlers equipped with a ventilation cooling device according to an embodiment of the present invention.

FIG. 3 is a perspective view illustrating the lower plate of the seat for infants and toddlers equipped with a ventilation cooling device according to an embodiment of the present invention.

FIG. 4 is a plan view illustrating the seat for infants and toddlers equipped with a ventilation cooling device according to an embodiment of the present invention.

FIG. 5 is a side cross-sectional view illustrating the seat for infants and toddlers equipped with a ventilation cooling device according to an embodiment of the present invention. FIG. 6 is an exemplary view showing a planar arrangement of the air guide in the seat for infants and toddlers equipped with a ventilation cooling device according to an embodiment of the present invention.

FIG. 7 is a use state diagram illustrating the seat for infants and toddlers equipped with a ventilation cooling device according to an embodiment of the present invention.

FIG. 8 is a perspective view illustrating the seat for infants and toddlers equipped with a ventilation cooling device according to another embodiment of the present invention.

FIG. 9 is a use state diagram illustrating the seat for infants and toddlers equipped with a ventilation cooling device according to another embodiment of the present invention.

### BEST MODE

Hereinafter, exemplary embodiments of the present invention will be described in detail with reference to the accompanying drawings so that those skilled in the art to which the present invention pertains may easily practice the same. However, since the description of the present invention is illustrative only for structural or functional description, the scope of the present invention should not be interpreted as being limited by the embodiments described in the text. That is, since the embodiments may be variously changed and have different forms, it should be understood that the scope of the present invention includes equivalents capable of realizing technical ideas. In addition, the purposes or effects presented in the present invention do not mean that a specific embodiment should include all thereof or only the effects described above, instead, the scope of the present invention should not be understood as being limited thereby.

The meaning of the terms described in the present invention should be understood as follows.

Terms such as “first” and “second” are for distinguishing one component from other components, and the scope of rights should not be limited by these terms. For example, the first component may be referred to as the second component, and similarly, the second component may also be referred to as the first component. When a component is said to be “connected” to another component, it may be understood that these components may be directly connected to each other, or other components may exist there between. On the other hand, when a component is said to be “directly connected” to another component, it should be understood that no other component exists there between. On the other hand, other expressions describing the relationship between the components, that is, “between” and “immediately between” or “neighboring” and “directly neighboring” should be interpreted similarly.

Singular expressions are to be understood as including plural expressions unless the context clearly indicates otherwise, and terms such as “include” or “have” refer to the existence of the features, numbers, steps, actions, components, parts described herein or a combination thereof. However, it is to be understood that the combination is not intended to preclude the existence or addition possibility of one or more other features or numbers, steps, operations, components or parts, or combinations thereof.

All terms used herein have the same meaning as generally understood by those skilled in the art to which the present invention pertains, unless otherwise defined. Terms generally used and defined in the dictionary should be interpreted as being consistent with meanings in the context of related technologies, and cannot be interpreted as having ideal or excessively formal meanings unless explicitly defined in the present invention.

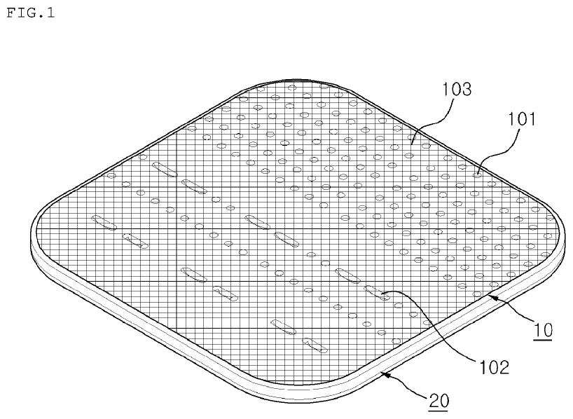

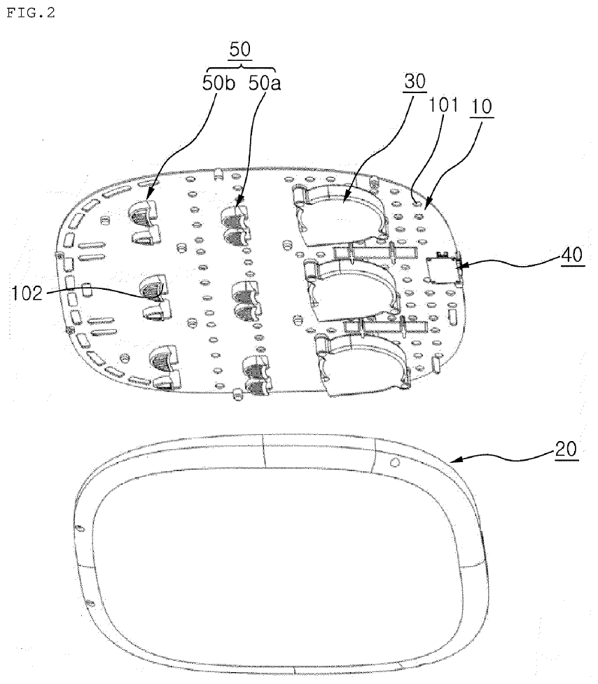

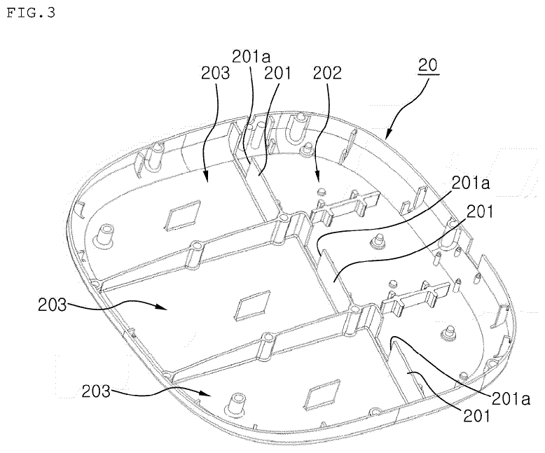

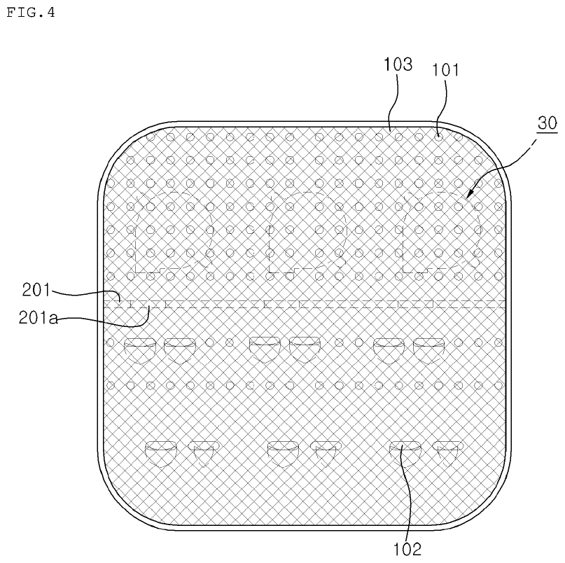

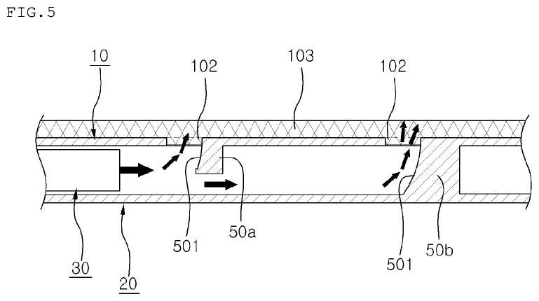

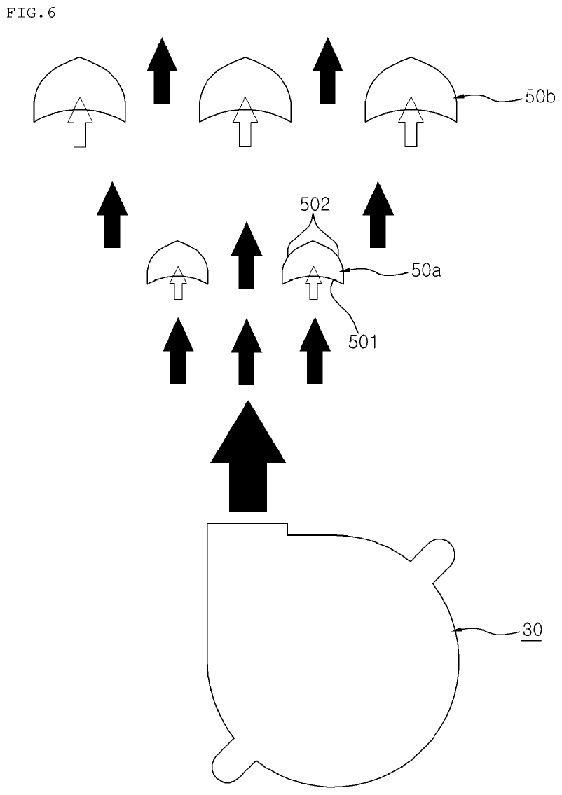

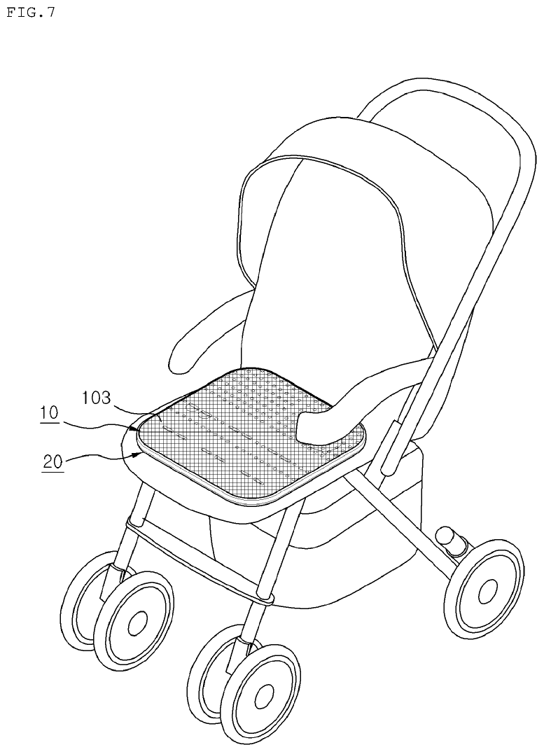

FIG. 1 is a perspective view illustrating the seat for infants and toddlers equipped with a ventilation cooling device according to an embodiment of the present invention; FIG. 2 is an exploded perspective view illustrating the seat for infants and toddlers equipped with a ventilation cooling device according to an embodiment of the present invention; FIG. 3 is a perspective view illustrating the lower plate of the seat for infants and toddlers equipped with a ventilation cooling device according to an embodiment of the present invention; FIG. 4 is a plan view illustrating the seat for infants and toddlers equipped with a ventilation cooling device according to an embodiment of the present invention; FIG. 5 is a side cross-sectional view illustrating the seat for infants and toddlers equipped with a ventilation cooling device according to an embodiment of the present invention; FIG. 6 is an exemplary view showing a planar arrangement of the air guide in the seat for infants and toddlers equipped with a ventilation cooling device according to an embodiment of the present invention; and FIG. 7 is a use state diagram illustrating the seat for infants and toddlers equipped with a ventilation cooling device according to an embodiment of the present invention. The following description will be given with reference to FIGS. 1 to 7.

The seat for infants and toddlers (“seat”) equipped with a ventilation cooling device according to the present invention may include an upper plate 10, a lower plate 20, a blowing fan 30, a power supply unit 40 and an air guide 50. The upper plate 10 may include a plurality of air intake ports 101 and air exhaust ports 102 which is formed on a wall located on an upper side thereof. In other words, when viewed on a plane, the upper plate 10 is partitioned back and forth to form a plurality of air intake ports 101 at a predetermined interval in the front, as well as a plurality of air exhaust ports 102 at a predetermined interval in the rear.

It is noted that the air intake port 101 and the exhaust port 102, respectively, are formed in plural at a predetermined interval in horizontal and vertical directions, wherein a planar shape or size thereof is not particularly limited.

On the other hand, the top surface of the upper plate 10 is preferably provided with a mesh fabric 103 attached thereto. The mesh fabric 103 may prevent foreign matter from flowing into the air intake port 101 and the air exhaust port 102 while smoothly communicating air through the air intake port 101 and the air exhaust port 102.

The lower plate 20 may be coupled to the lower portion of the upper plate 10, wherein an inner space is partitioned into an air intake space 202 and an air exhaust space 203 by a partition wall 201a and these two spaces are connected to each other through a vent 201a with a predetermined size formed in the partition wall 201.

That is, the air intake space 202 may communicate with the air intake port 101 formed in the upper plate 10, and the air exhaust space 203 may communicate with the air exhaust port 102 formed in the upper plate 10.

Therefore, the external air introduced through the air intake port 101 flows into the air intake space 202 in the lower plate 20, moves to the air exhaust space 203 in the lower plate 20 through the vent 201a of the partition wall 201, and then, is finally discharged to the outside through the air exhaust port 102 in communication with the air exhaust space 203.

At this time, areas of the air intake space 202 and the air exhaust space 203 formed in the lower plate may be determined in a ratio of 4:6, whereby, when air in the air intake space 202 is discharged to the air exhaust space 203 by the blowing fan 30, an area covered by the blowing fan 30 is decreased to thus reduce the number of the blowing fan 30 to be installed and a capacity there of, as well as power consumption for operation of the blowing fan 30. Further, noise caused by the operation of the blowing fan 30 may be minimized.

The blowing fan 30 may be installed inside the air intake space 202 wherein an air intake portion directly connects to the air intake port 101 in the upper plate 10, while an air exhaust portion is disposed in line with the vent 201a formed in the partition wall 201.

Therefore, the external air in the air intake port 101 forcedly sucked by the blowing fan 30 may be discharged to the air intake space 202, wherein the air moves to the air exhaust space 203 in the lower plate 20 through the vent 201a in the partition wall 201 and is finally discharged to the outside through the air exhaust port 102 in communication with the air exhaust space 203.

At this time, air can be quickly discharged through the air exhaust port 102 by a discharge pressure of the blowing fan 30.

The blowing fan 30 may be disposed inside the air intake space 202, however, it is noted that the blowing fan 30 can be mounted at any position of the lower surface of the upper plate 10 or the bottom of the lower plate 20.

The power supply unit 40 may be connected to an external portable battery through a power supply cable in order to supply power to the blowing fan 30, or an internal battery may be integrally configured to supply power to the blowing fan 30.

The power supply unit 40 is preferably installed adjacent to the blowing fan 30 on one side of the upper plate 10 or the lower plate 20 on which the blowing fan 30 is installed. Therefore, it is possible to improve transportability and convenience of a final product by configuring the battery in an external or embedded type according to the specifications or size of the final product.

The air guide 50 may be formed at the lower portion of the air exhaust port 102 and, when the air discharged from the air intake space 202 to the air exhaust space 203 by the blowing fan 30 is finally exhausted through the air exhaust port 102, may guide air flow, thus enabling rapid discharge of air.

The air guide 50 may include a first air guide 50a and a second air guide 50b.

The first air guide 50a may be provided in plural at a predetermined interval adjacent to the blowing fan 30, wherein a lower surface of the first air guide is formed to be spaced apart from the bottom surface of the lower plate 20, whereby air can pass even through a space between the lower surface of the first air guide 50a and the bottom surface of lower plate 20.

The second air guide 50b may be provided in plural at a predetermined interval to be spaced farther from the blowing fan 30 than the first air guide 50a, and may be disposed in a zigzag manner with the first air guide 50a on the same plane.

Therefore, air moving from the air intake space 202 to the air exhaust space 203 may meet the first air guide 50a adjacent to the blowing fan 30, and then, may be firstly discharged to the outside through the air exhaust port 102 connected to the first air guide 50a. Subsequently, the air passing between a plurality of first air guides 50a may be secondly discharged to the outside through the air exhaust port 102 connected to the second air guide 50b by the second air guides 50b disposed in a zigzag manner with the first air guides 50a in the same plane. As a result, the air is evenly exhausted through a plurality of air exhaust ports 102 in communication with the air exhaust space 203. Further, since the second air guide 50b has a larger size than the first air guide 50a and the lower surface thereof is in close contact with the bottom surface of the lower plate 20, when air passing between a plurality of first air guides 50a meets the second air guides 50b, the air may be discharged more efficiently through the air exhaust port 102 connected to the second air guide 50b while meeting the second air guide 50b having a larger surface area.

That is, since the second air guide 50b is farther away from the blowing fan 30 than the first air guide 50a, when air moves from the air intake space 202 to the air exhaust space 203, a pressure of the air reaching the second air guide 50b is weakened. However, since the second air guide 50b has a larger surface area than the first air guide 50a, air discharge may be more smoothly induced when inducing air discharge through the air exhaust port 102.

On the other hand, the air guide 50 may be formed in a column shape having a triangular cross-section, whereby a slope inducing surface 501 connected to the air exhaust port 102 is formed on one side of the air guide.

In other words, when viewed from the lateral side, the slope inducing surface 501 is formed at one side in order to have a wide horizontal width at the bottom and a narrow vertical width at the top thereof, whereby the air moving from the air intake space 202 toward the air guide 50 can be rapidly discharged along the slope inducing surface 51 to the air exhaust port 102 disposed on an upper portion of the air guide 50.

At this time, the slope inducing surface 501 is formed to be concave inwardly and, when the air flowing into the discharge space and then exhausted through the air exhaust port 102 is guided by the air guide 50 and discharged to the air exhaust port 102, the air can be further rapidly discharged.

In addition, with regard to the air guide 50 formed in a column shape having a triangular cross-section and provided with the slope inducing surface 501, the other two sides of the air guide 50 may be formed symmetrically as vortex prevention surfaces 502 which are outwardly convex, so that, when the air passing through the air guide 50 passes the vortex prevention surface 502, occurrence of vortex around the vortex prevention surface 502 may be prevented, enabling more smooth air flow and air discharge through the air exhaust port 102.

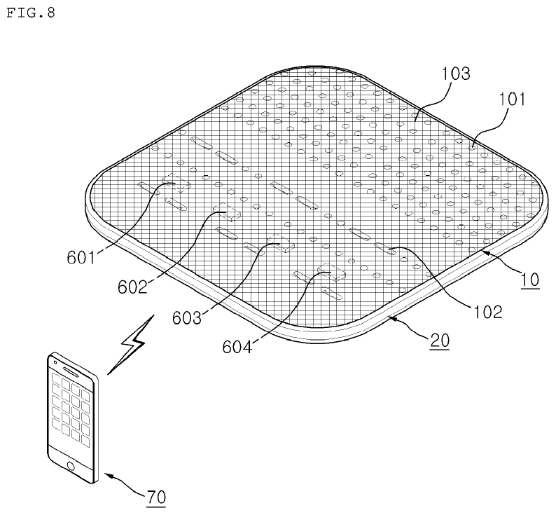

FIG. 8 is a perspective view illustrating the seat for infants and toddlers equipped with a ventilation cooling device according to another embodiment of the present invention.

The following description will be given with reference to FIG. 8.

At one side of the upper plate 10, a pressure sensor 601 that senses the pressure applied to the top surface of the upper plate and provides a signal for controlling the power supply to the power supply unit 40 may be further provided. That is, when a body portion of a baby (“baby body”)is in close contact with the upper plate 10, a pressure applied by the baby's body weight is sensed and, only when the baby body is in close contact therewith, the power supply unit 40 may supply power to the blowing fan 30. The power may be efficiently used by automatically controlling the power supply.

Further, a temperature sensor 602, a humidity sensor 603 and a control module 604 may be further provided at one side of the upper plate 10.

The temperature sensor 602 may be installed on one side of the upper plate 10 to measure a temperature around the upper plate 10, particularly, at a site adjacent to the baby body in close contact with the upper plate 10.

The humidity sensor 603 may be installed on one side of the upper plate 10 to measure humidity around the upper plate 10, particularly, at a site adjacent to the baby body in close contact with the upper plate 10.

The control module 604 may wirelessly transmit a measured temperature from the temperature sensor 602 and a measured humidity from the humidity sensor 603 to a mobile terminal in which a dedicated application is installed, while receiving a control signal from the mobile terminal 70 in order to control the blowing fan 30.

The control module 604 is preferably provided with a wireless communication module for wireless communication with the mobile terminal 70.

The wireless communication module may employ well-known short-range wireless communication such as Wi-Fi, Bluetooth, etc. or a personal area network (PAN), which is linked to IoT using Bluetooth, ZigBee, UWB (Ultra-Wide Band), etc. and exchanges data with the mobile terminal 70.

The mobile terminal 70 is a device capable of exchanging data through a wireless link, which is a comprehensive concept of portable devices. That is, multimedia phones and multimedia players including, for example, a PDA (Personal Digital Assistant), a GSM (Global System for Mobile) phone, a WCDMA (Wide band CDMA) phone, a CDMA-2000 phone, an MBS (Mobile Broadband System) phone, a PMP (Portable Multimedia Player), a handheld computer (Handheld Computer), or the like, may be included. In this regard, the MBS phone may be a mobile phone to be used in the 4th generation system currently being discussed and is preferably possessed by a baby guardian.

The mobile terminal 70 receiving the measured temperature and the measured humidity from the control module 604 may display the temperature and humidity around the upper plate 10 in real time through the dedicated application.

At this time, the dedicated application may compare pre-stored appropriate temperature and humidity with the temperature and humidity provided from the control module 604 and displayed in real time, so that the guardian can check or determine whether the temperature and humidity around the upper plate 10 of the seat for infants and toddlers equipped with a ventilation cooling device are appropriate or not.

Further, if the temperature and humidity around the upper plate 10 are not appropriate, a blowing speed of the blowing fan 30 may be adjusted in multiple stages such as first, second or third mode, sleep mode, normal mode, strong mode, etc., through a dedicated application. Therefore, the control signal may be transmitted from the mobile terminal to the control module 604. As a result, due to the control signal, a rotational speed of the blowing fan 30 may be adjusted to thus control the temperature and humidity around the upper plate 10.

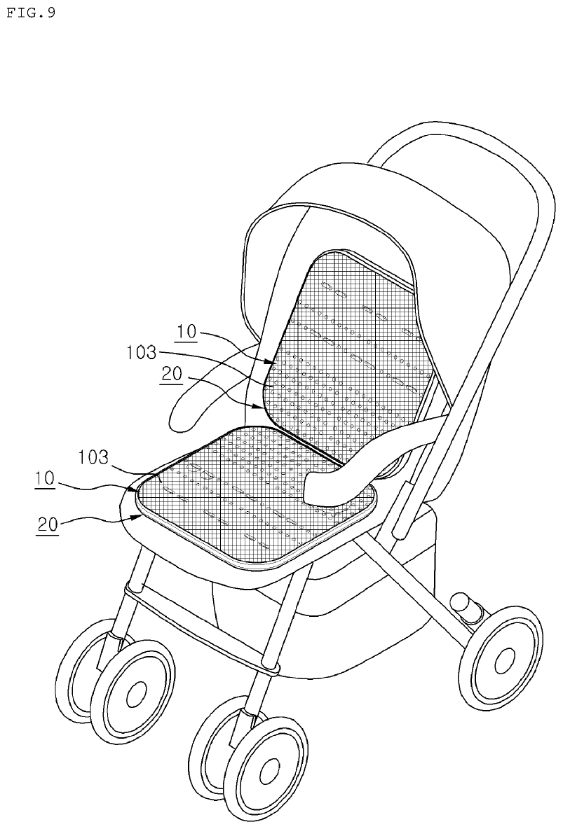

FIG. 9 is a use state diagram illustrating the seat for infants and toddlers equipped with a ventilation cooling device according to another embodiment of the present invention.

The following description will be given with reference to FIG. 9.

In the above description with reference to FIGS. 1 to 8, the seat for infants and toddlers equipped with a ventilation cooling device according to the present invention is illustrated in a cushion form, but is not limited thereto, as shown in FIG. 9.

Specifically, a cushion seat and a back seat may be used as well.

Further, it is noted that the cushion seat and the back seat are provided together, but may also be configured in an angle-adjustable form.

As described above, the embodiment of the present invention is not implemented only through the above-described apparatus and/or operating method, and may also be conducted through a program for implementing a function corresponding to the configuration of the embodiment of the present invention, a recording medium in which the program is recorded, and the like. The implementation described above may be easily achieved from the description of the above embodiments by those skilled in the art to which the present invention pertains. Although the embodiments of the present invention have been described in detail above, the scope of the present invention is not limited thereto, and various modifications and improvements may also be within the scope of the present invention by those skilled in the art who can use the basic concept of the present invention defined in the appended claims.

1. A seat for infants and toddlers equipped with a ventilation cooling device, comprising:
an upper plate (10) in which a plurality of air intake ports 101 and air exhaust ports (102) are formed;
a lower plate (20) coupled to a bottom of the upper plate (10), and having an inner space partitioned into an air intake space (202) and an air exhaust space (203) by a partition wall (201), wherein these two spaces communicate with each other through a vent (201a) with a predetermined size formed in the partition wall (201);
a blowing fan (30) installed inside the air intake space (202) in order to intake air outside the air intake ports (101) and then exhaust the same through the air exhaust ports (102) communicating with the air exhaust space 203;
a power supply unit (40) to supply power to the blowing fan (30); and
an air guide (50) disposed at a lower portion of the air exhaust ports (102) to guide air discharge.

2. The seat according to claim 1, wherein the air guide (50) includes: a first air guide (50a) which is formed in plural at a predetermined interval adjacent to the blowing fan (30) while having a lower surface to be spaced apart from the bottom surface of the lower plate (20); and
a second air guide (50b) which is formed in plural at a predetermined interval to be spaced farther apart from the blowing fan (30) than the first air guide (50a), wherein the first air guides 50a and the second air guides (50b) are disposed in a zigzag manner on a plane, and each second air guide (50b) has a larger size than each first air guide 50a while a lower surface thereof is in close contact with the bottom surface of the lower plate (20).

3. The seat according to claim 1, wherein the air guide (50) is formed in a column shape having a triangular cross-section,
wherein a slope inducing surface (501) is formed to be connected to the air exhaust port (102) on one side of the air guide, and
the slope inducing surface (501) is formed to be concave inwardly.

4. The seat according to claim 3, wherein the air guide (50) further includes a vortex preventing surface (502) provided symmetrically on the other side thereof, which is convex outwardly.

5. The seat according to claim 1, wherein the upper plate further includes a pressure sensor (601) on one side thereof, which senses pressure applied to the top surface of the upper plate and transmits a signal for controlling power supply to the power supply unit 40.

6. The seat according to claim 1, further comprising:
a temperature sensor (602) for measuring ambient temperature;
a humidity sensor (603) for measuring ambient humidity; and
a control module (604) that transmits a temperature measured by the temperature sensor (602) and a humidity measured by the humidity sensor (603) to a mobile terminal (70), while receiving a control signal from the mobile terminal (70), so as to control the blowing fan (30), wherein these components are provided at one side of the upper plate (10).
